(19) United States
(12) Patent Application Publication
(10) Pub. No.: US 2026/0079531 A1
(43) Pub. Date: Mar. 19, 2026

(54) ULTRA-TOUGH, HIGH-STRENGTH TRANSPARENT PROTECTIVE LAYERS ON FLEXIBLE DISPLAY GLASS AND PREPARATION METHOD THEREOF

(71) Applicant: City University of Hong Kong, Hong Kong (HK)

(72) Inventors: Jian LU, Hong Kong (HK); Pengfei LIU, Hong Kong (HK); Yu BU, Shenzhen (CN); Xufen XIAO, Shenzhen (CN)

(21) Appl. No.: 18/884,162

(22) Filed: Sep. 13, 2024

(51) Int. Cl. G06F 1/16; C03C 17/245; C03C 21/00; C03C 23/00

(52) U.S. Cl. CPC G06F 1/1652; C03C 17/245; C03C 21/002; C03C 23/006; C03C 2217/229; C03C 2217/78; C03C 2218/154; C03C 2218/31; G06F 2200/1634

(57) ABSTRACT

Provided herein is a bendable display device is provided herewith, comprising a display glass panel comprising a multi-layered metal oxide nanostructure and configured to display visual images, and a transparent protection film deposited on the display glass panel. The bendable display device demonstrates significantly improved mechanical properties including surface ductility, stability and bendability, while maintaining high transmittance and transparency for excellent optical display. A method of fabricating the bendable display device is also provided.

### TECHNICAL FIELD

The present invention relates to display screen protective layers. More specifically, the present invention presents an ultra-tough and high-strength transparent protective layers applicable to flexible display panels, and method of fabrication thereof.

### BACKGROUND

The development of organic light-emitting diodes (OLEDs), organic compounds that demonstrate luminescence upon application of electric current, is crucial for the emergence of flexible display technology, due to the compounds'inherent flexibility over the traditional LEDs which are relatively rigid.

Among the flexible display materials, flexible display glass, defined as bendable ultra-thin glass substrate with a thickness of less than 100 μm, is of particularly high application value in electronic products due to its multitude of advantages, including but not limited to its extremely low thickness, small bending radius, high transmittance and thermal dimensional stability.

In recent years, flexible display glass has been further explored and applied commercially. Folding or rolled-screen mobile phones with flexible display glass have been launched by several mobile phone manufacturers, showcasing the progress of fabricating and incorporating flexible display glass into electronic display on flexible surfaces.

However, flexible display glass materials still face a major drawback of having relatively low surface ductility, meaning that the material is still prone to plastic deformation under tensile stress which may ultimately lead to fractures. This means that the optical displays using these materials may show brittleness and microcracks upon bending, which, in preventing such phenomena from happening, would limit the bending radius of the material in turn.

It should be pointed out that, in addition to performance degradation such as loss of touch sensitivity, under extreme bending angles, the fractured flexible display glass materials may produce sharp glass fragments or shards, which poses major safety risks to users in consumer electronics including smartphones and tablets.

Therefore, there is a need to develop a flexible display material with high-strength and high-toughness protective layers for an increased surface ductility if the flexible glass material while retaining high transparency, and maintaining a reasonable cost-effectiveness and ease of application for mass production. The present invention addresses this need.

### SUMMARY OF THE INVENTION

In one aspect of the present invention, a bendable display device is provided herewith, comprising a display glass panel comprising a multi-layered metal oxide nanostructure and configured to display visual images, and a transparent protection film deposited on the display glass panel.

The transparent protection film is specifically engineered to have a thickness of less than 1000 nm, and a transmittance of at least 93%.

The bendable display device demonstrates a surface ductility of at least 50 N; a bending radius of less than 1 mm.

In one embodiment of the first aspect of the present invention. The metal oxide in the multi-layered metal oxide nanostructure is selected from indium tin oxide, aluminium-doped zinc oxide, or indium-doped cadmium oxide.

In another embodiment, the device is fabricated by in-situ deposition of the transparent protection film on the display glass panel.

In a second aspect of the present invention, a method of fabricating the bendable display device is also provided herewith. The method comprises preparing a transparent protection comprising a multi-layered metal oxide nanostructure; vaporizing the multi-layered metal oxide nanostructure into gaseous form; transferring the vaporized multi-layered metal to display glass panel; and forming a transparent protection film on the display glass panel by allowing the vaporized multi-layered metal to condense on the display glass panel.

In one embodiment of the second aspect, the metal oxide in the multi-layered metal oxide nanostructure is selected from indium tin oxide, aluminium-doped zinc oxide, or indium-doped cadmium oxide.

In another embodiment, the transparent protection film has a thickness of less than 1000 nm.

In other embodiment, the transparent protection film has a transmittance of at least 93%.

In yet another embodiment, the bendable display device has a surface ductility of at least 50 N.

In yet other embodiment, the bending radius of the bendable display device is less than 1 mm.

### BRIEF DESCRIPTION OF DRAWINGS

The appended drawings, where like reference numerals refer to identical or functionally similar elements, contain FIG. s of certain embodiments to further illustrate and clarify the above and other aspects, advantages and features of the present invention. It will be appreciated that these drawings depict embodiments of the invention and are not intended to limit its scope. The invention will be described and explained with additional specificity and detail through the use of the accompanying drawings in which:

FIG. 1 provides a schematic diagram of the “sandwich” nanostructure of the transparent protection layer 100 of the present invention, consisting of multiple metal oxide layers 110.

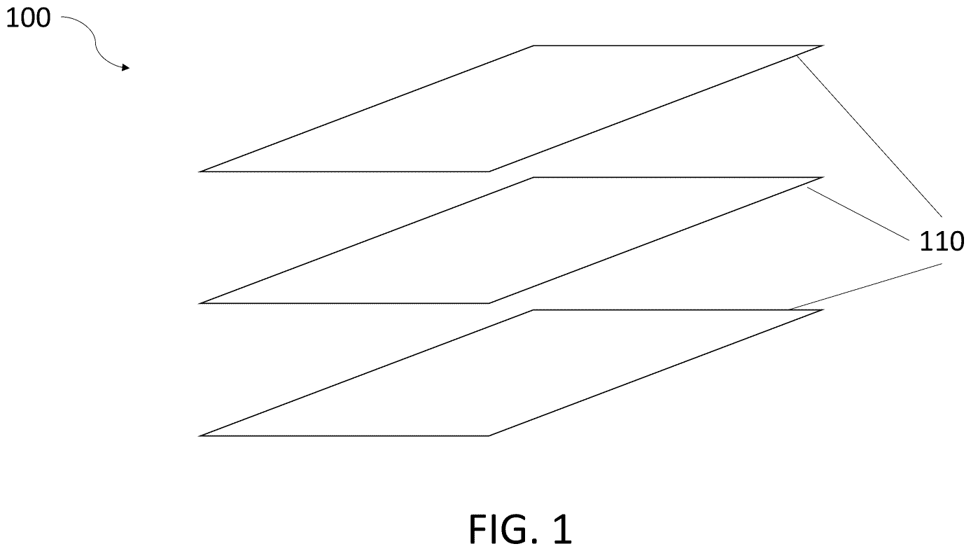

FIG. 2 provides a schematic diagram of the overall structure of the bendable display device 200 of the present invention, comprising the transparent protection layer 100, a plasma treatment layer 120, ion-exchange layer 130, all deposited onto the glass substrate 140.

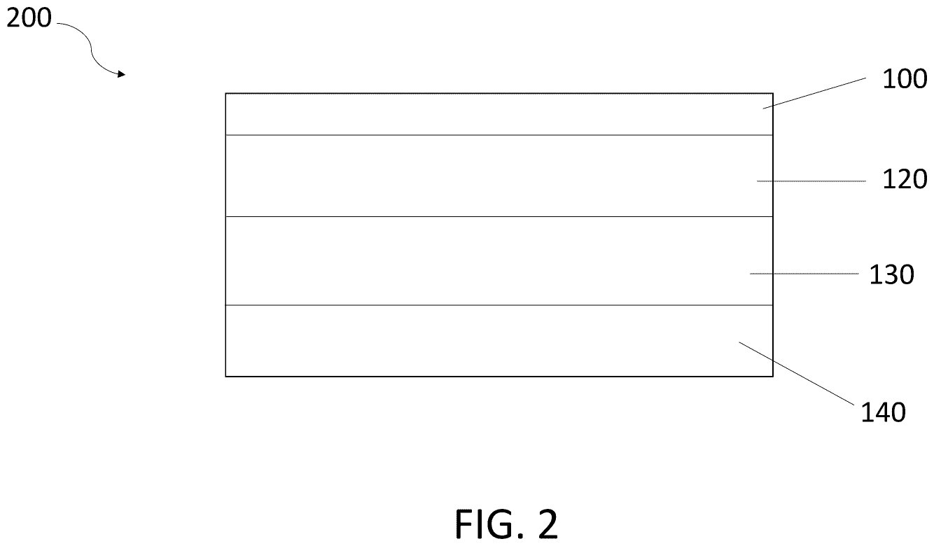

### DETAILED DESCRIPTION

To address the issues of mechanical robustness and ductility of the existing flexible display glass, and hence improved performances, mechanical strengths and lifespan of bendable or rolled-screen electronic devices, the present invention provides an ultra-tough, high-strength transparent protective film.

The ultra-tough, high-strength transparent protective film has a “sandwich” nanostructure consisting of multiple metal oxide nanolayers which, when deposited onto a flexible display glass substrate, improves the surface ductility, stability and protection of the flexible display glass, while the high transparency of the protective film ensures the compromises of optical qualities of the flexible display glass is minimal.

In particular, the ultra-tough, high-strength transparent protective film is engineered to facilitate in-situ deposition onto the flexible display glass through common physical vapor deposition (PVD) process.

In the PVD process, the multiple metal oxide nanolayers forming a “sandwich” nanostructure is vaporized in a vacuum chamber, and transferred to the flexible display glass substrate uniformly. Upon condensation, the ultra-tough, high-strength transparent protective film is formed, and optionally, additional post-treatments could be applied to further enhance the properties of the ultra-tough, high-strength transparent protective film.

By applying the ultra-tough, high-strength transparent protective film as a coating to the flexible display glass substrate through PVD technology, complex multi-layer structural design is possible, while also enabling great programmability and customizability of the coating process and designs.

Specifically, the bendable display device in the present invention is fabricated based on materials and techniques which are commercially available and open-end feedstock systems.

The ultra-tough, high-strength transparent protective film is applicable to all flexible display glass substrates, including but not limited to commercially available flexible display glass products such as Corning Willow Glass, AGC's Dragontail™, or Schott's D 263® T eco.

Additionally, while the ultra-tough, high-strength transparent protective film comprises multiple overlapping layers of metal oxides forming a “sandwich” nanostructure, the metal oxides can be selected from, for example, indium tin oxide, aluminium-doped zinc oxide, indium-doped cadmium oxide, which are commercially available and accessible.

Coupled with PVD coating technology which is widely applied across the industry, the fabrication method of the bendable display device in the present invention is of vast commercial potential and industrial applicability, mass production of which is attainable.

### EXAMPLES

A bendable display device is designed herewith, comprising a display glass panel pre-treated with ion-exchange wherein the display glass panel comprises flexible glass materials, pre-treated with ion-exchange chemical treatment and plasma treatment.

The transparent protection film comprises a multi-layered metal oxide nanostructure. Specifically, the multiple layers of nanometric metal oxides are arranged in a compact laminated “sandwich” structure. This allows a minimum thickness while optimizing the performance of the display panel in terms of transmittance.

The transparent protection film is configured to possess a thickness of less than 1000 nm. For example, to achieve higher flexibility of the display device, the protection film can be configured at a thickness of range of 500 nm to 750 nm. In another example, otherwise, the protection film can be configured at a thickness of range of 750 nm to 1000 nm to optimize mechanical strength and ductility without further compromising transmittance.

The transparent protection film is configured to have a transmittance of at least 93%. Accordingly, one example is to configure the protection film to have a transmittance of 93% to 96% to enable relative low-cost production. In another example, the transmittance of the protection film can be configured up to 99% for optimal transparency and clarity of display.

The bendable display device has a surface ductility of at least 50 N. For example, the ductility can range from 50 N to 80 N.

The bending radius of the bendable display device is less than 1 mm. For example, the bending radius can range from 0.6 mm to 0.9 mm.

Before the vaporization and deposition of the transparent protection film through PVD technology onto the display glass substrate, the glass substrate is subjected to prior ion-exchange chemical treatment and plasma treatment.

The ion-exchange chemical treatment comprises subjecting the glass substrate to a molten potassium salt bath at a temperature of at least 300° C., for example in a range of 300° C. to 450° C.

The plasma treatment comprises preparing a sputtering chamber by adjusting the sputtering power and temperature, and simultaneously introducing argon and a reaction gas to form a plasma-pretreated glass substrate for further PVD process.

The sputtering power of the sputtering chamber is adjusted to a range of 200 W to 800 W. For example, the sputtering power can be adjusted to a range of 450 W to 650 W.

The temperature of the sputtering chamber, on the other hand, is adjusted to less than 1000° C., for example in a range of 500° C. to 800° C.

The reaction gas that is simultaneous introduced with argon is selected from oxygen or nitrogen. Further, the ratio of partial pressures of the argon to the reaction gas is 60:40 to 80:20. For example, the ratio of partial pressures of argon to reaction gas is selected from 70:30 to 75:25.

Throughout this specification, unless the context requires otherwise, the word “comprise” or variations such as “comprises” or “comprising”, will be understood to imply the inclusion of a stated integer or group of integers but not the exclusion of any other integer or group of integers. It is also noted that in this disclosure and particularly in the claims and/or paragraphs, terms such as “comprises”, “comprised”, “comprising” and the like can have the meaning attributed to it in U.S. Patent law; e.g., they allow for elements not explicitly recited, but exclude elements that are found in the prior art or that affect a basic or novel characteristic of the present invention.

Furthermore, throughout the specification and claims, unless the context requires otherwise, the word “include” or variations such as “includes” or “including”, will be understood to imply the inclusion of a stated integer or group of integers but not the exclusion of any other integer or group of integers.

References in the specification to “one embodiment”, “an embodiment”, “an example embodiment”, etc., indicate that the embodiment described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Other definitions for selected terms used herein may be found within the detailed description of the present invention and apply throughout. Unless otherwise defined, all other technical terms used herein have the same meaning as commonly understood to one of ordinary skill in the art to which the present invention belongs.

It will be appreciated by those skilled in the art, in view of these teachings, that alternative embodiments may be implemented without undue experimentation or deviation from the spirit or scope of the invention, as set forth in the appended claims. This invention is to be limited only by the following claims, which include all such embodiments and modifications when viewed in conjunction with the above specification and accompanying drawings.

1. A bendable display device comprising a display glass panel configured to display visual images and a transparent protection film deposited on the display glass panel, wherein:
the display glass panel comprises flexible glass materials;
the transparent protection film comprises a multi-layered metal oxide nanostructure;
the transparent protection film has a thickness of less than 1000 nm;
the transparent protection film has a transmittance of at least 93%;
the bendable display device has a surface ductility of at least 50 N;
the bending radius of the bendable display device is less than 1 mm.

2. The bendable display device of claim 1, wherein the metal oxide in the multi-layered metal oxide nanostructure is selected from indium tin oxide, aluminium-doped zinc oxide, or indium-doped cadmium oxide.

3. The bendable display device of claim 1, wherein the device is fabricated by in-situ deposition of the transparent protection film on the display glass panel.

4. A method of fabricating the bendable display device of claim 1, comprising:
preparing a transparent protection comprising a multi-layered metal oxide nanostructure;
vaporizing the multi-layered metal oxide nanostructure into gaseous form;
preparing a display glass panel by providing a glass substrate subjected to ion-exchange chemical treatment and plasma treatment;
transferring the vaporized multi-layered metal to display glass panel; and
forming a transparent protection film on the display glass panel by allowing the vaporized multi-layered metal to condense on the display glass panel.

5. The method of claim 4, wherein the ion-exchange chemical treatment comprises subjecting the glass substrate to a molten potassium salt bath at a temperature of at least 300°C.

6. The method of claim 4, wherein the plasma treatment comprises:
preparing a sputtering chamber by adjusting the sputtering power and temperature, subjecting the glass substrate into the sputtering chamber; and
simultaneously introducing argon and a reaction gas to form a plasma-pretreated glass substrate.

7. The method of claim 6, wherein the reaction gas is selected from oxygen or nitrogen.

8. The method of claim 6, wherein the sputtering power is selected from a range of 200 W to 800 W.

9. The method of claim 6, wherein the partial pressure of argon is selected from 60% to 80%; and the partial pressure of the reaction gas is selected from 20% to 40%.

10. The method of claim 6, wherein the duration of the plasma treatment is selected from 10 minutes to 180 minutes.

11. The method of claim 6, wherein the temperature of the sputtering chamber is less than 1000° C.

12. The method of claim 4, wherein the metal oxide in the multi-layered metal oxide nanostructure is selected from indium tin oxide, aluminium-doped zinc oxide, or indium-doped cadmium oxide.

13. The method of claim 4, wherein the transparent protection film has a thickness of less than 1000 nm.

14. The method of claim 4, wherein the transparent protection film has a transmittance of at least 93%.

15. The method of claim 4, wherein the bendable display device has a surface ductility of at least 50 N.

16. The method of claim 4, wherein the bending radius of the bendable display device is less than 1 mm.
